(19) United States
(12) Patent Application Publication
(10) Pub. No.: US 2005/0188808 A1
(43) Pub. Date: Sep. 1, 2005

(54) Trimmer with laser guide

(76) Inventors: Michael Parrish, Westerville, OH (US); Thomas Wiberg, Statesville, NC (US); Robert Anderson, Mooresville, NC (US); John Gardiner, Statesville, NC (US)

Correspondence Address: MCNEES, WALLACE & NURICK LLC, 100 PINE STREET, P.O. BOX 1166, HARRISBURG, PA, 17108-1166, US

(21) Appl. No.: 11/002,572

(22) Filed: Dec. 2, 2004

Related U.S. Application Data
(60) Provisional application No. 60/526,695, filed on Dec. 2, 2003.

(51) Int. Cl. B26D 7/27; B26D 7/28

(52) U.S. Cl. 83/522.11

(57) ABSTRACT

Cutting apparatus and methods are provided for cutting and trimming of flat materials, the invention incorporating an optical guide means for positioning of the flat material in a desired orientation. A laser device is positioned on a cutter to project a visual indication of the line of cut to be made by the cutting blade, and optionally along other lines such as to show a border or margin. Means are provided to power the laser device, and an optical element is provided to focus an emitted beam onto the cutter base, and any material placed thereon. Additionally the cutter includes a switching means for turning the laser device on and off. The switch can be mounted anywhere on the base or the cutting assembly. The cutter includes a cutting base for supporting the materials to be cut, a cutting blade assembly, and assistive cutting means such as a bottom blade on one edge of the base or a pad cooperating with the cutting blade to cut the flat material. The cutting blade can be of any type including, but not limited to, a guillotine blade and a rotary blade.

### PRIORITY CLAIM/CROSS-REFERENCE TO RELATED APPLICATIONS

This application claims priority to U.S. provisional patent application Ser. No. 60/526695, filed Dec. 2, 2003. That application is hereby incorporated by reference as though fully set forth herein.

### BACKGROUND OF THE INVENTION

The present invention relates generally to flat material cutting/trimming apparatus, and more particularly to flat material cutting/trimming machines having an optical guide means to help in the positioning of the flat material for cutting/trimming.

Trimming machines typically include one or more blades configured to cut or trim an edge of a flat material to alter its size and to provide an attractive and neat appearance.

Many types of apparatus are known for trimming flat materials such as photographs and paper, the most well known probably being the standard guillotine type paper trimmer. In a standard guillotine trimmer, a base board on which paper is to be cut has one edge formed as a square cut hard metal blade. Pivotally secured to that edge is a second metal blade cooperating therewith in the manner of a pair of scissors such that the second metal blade may be brought down to cut off any paper projecting over the edge of the fixed blade. There are several varieties of commercially available guillotine trimmers and such trimmers are well known in the art. Examples of such trimmers are disclosed in U.S. Pat. Nos. 215,205, 2,591,472, and 5,320,011.

In recent years, rotary paper trimmers have been developed that replace the pivotal blade with a rotating cutter wheel. In one type of rotary paper trimmer, the rotating cutter wheel is caused to travel along a rail assembly over the paper or material to be cut, the cutter wheel having a blade formed along the outer edge of the wheel that cuts the material as it moves there over. The rotary blade can cooperate with a lower stationary blade or edge, or with a sacrificial or self-healing pad that eliminates the need for the lower blade. Examples of trimmers of this type are described in U.S. Pat. No. 5,069,097 entitled “Paper-Cutting Machine And Method Of Cutting Paper” to Mon issued on Dec. 3, 1991, U.S. Pat. No. 5,322,001 assigned to assignee of the present application and entitled “Paper Cutter With Circular Blades” to Boda issued on Jun. 21, 1994, and in U.S. Pat. No. 3,301,117 entitled “Paper Cutter to D. E. Spaulding issued on Jan. 31, 1967.

Generally, these trimmers provide a raised edge on the back of the trimmer, at a 90 degree angle to the edges of the blades, to enable precise right angle cuts. The material to be trimmed may be trimmed at a right angle by butting one edge of the material against the raised edge on the base in known fashion. Other methods for facilitating precise cuts include combining a trimmer with a ruler. For example U.S. Pat. No. 1,895,754 entitled “Measuring Stick” to Finkenwirth issued on Jan. 31, 1933 and U.S. Pat. No. 4,987,812 entitled “Combination Ruler And Cutter Guide” to Benavidez issued on Jan. 29, 1991 that discloses a cutter member which is slidably guided within a slot in a ruler.

Such alignment techniques do not address the need to align a cut at an irregular angle or to visually align such a cut. Despite various alignment tool, rulers and the like, the actual line of cut of the cutting blade is at best difficult to determine, making consistent, precise, aligned cuts impossible. For example, with guillotine type trimmers, while the location of the edge of the lower blade, and ultimately the location of the cut, can be estimated by coordination of the visual observed location of where the edges of the material meet the blade edge, once the material is placed in a cutting position, the material covers the lower blade edge and the actual line of the cut cannot be determined unless the material is transparent.

Therefore, a long-standing need has existed to provide a novel means by which the operator of a cutter can visually align or orient the material to be cut relative to the line of cut of the cutting blade(s). Also, such a means should eliminate the requirement for special measuring and/or the necessity for an independent guideline to be followed. The current invention addresses the shortcomings in the precision of current cutters by providing a visible indicator, preferably a laser-generated line, that visually indicates the line of cut of the cutting blade.

### BRIEF SUMMARY OF THE INVENTION

In view of the foregoing disadvantages inherent in the known types of cutters now present in the prior art, the present invention provides improved cutters with laser guides for more precise cutting.

An illuminating device, such as a laser device, is positioned on the cutter to project a visual indication of the line of cut to be made by the cutting blade. Means are provided to power the laser device, preferably a visible, low-power laser, such as a 630 to 670 nanometer wavelength laser at between about 0.1 to about 5 milliwatt power. An optical element fans the laser beam onto the cutter base, and any material thereon, into one or more visible lines.

Additionally, the cutter includes a switching means for turning the laser on and off. Such switching means can be momentary, proximity, or a toggling switch, for example. The switch can be mounted anywhere on the base or the cutting blade/blade arm for convenience.

The cutter for cutting and/or trimming sheets of flat material generally includes a cutting base for supporting the various materials, a cutting blade and a bottom blade on one edge of the base or a pad cooperating with the cutting blade to cut any material projecting over the edge of the bottom blade or inline with the cutting blade. The cutting blade can be of any type including, but not limited to, a guillotine blade and a rotary blade.

Other features and advantages of the present invention will be apparent from the following more detailed description of the preferred embodiments, taken in conjunction with the accompanying drawings which illustrate, by way of example, the principles of the invention, and from the appended claims.

### BRIEF DESCRIPTION OF THE DRAWINGS

FIG. 1 is a perspective view of a cutter including a guillotine cutting blade showing alternative mounting positions for the laser device in accordance with the present invention.

FIG. 2 is a perspective view of a cutter including a rotary cutting blade showing alternative mounting positions for the laser device in accordance with the present invention.

FIG. 3 is a partial perspective view of the cutting blade assembly handle of FIG. 1 in accordance with the present invention.

FIG. 4 is a partial perspective view of a handle of a guillotine type trimmer including a laser device mounted thereto in accordance with the present invention.

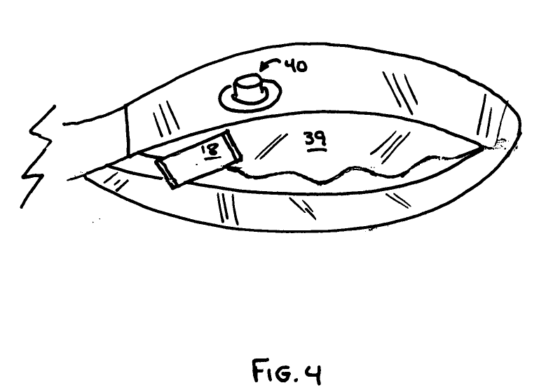

FIG. 5 is another embodiment of a cutter including a guillotine blade showing the laser device mounted in a housing provided in the base opposite the pivot attachment, in proximity to the lower cutting blade of the base in accordance with the present invention.

FIG. 6 is a partial perspective view, partially in section, of the trimmer of FIG. 5 showing the laser device mounted in the laser module housing of FIG. 5 in accordance with the present invention.

FIG. 7 is a perspective view of the bottom of the trimmer of FIG. 5 showing the laser module housing with a lower housing cover removed to access the power source and related circuitry in accordance with the present invention.

FIG. 8 is an exploded view of the laser housing module of FIG. 5 in accordance with the present invention.

FIG. 9 is a side perspective view of the assembled laser housing module of FIG. 8 in accordance with the present invention.

Wherever possible, the same reference numbers will be used throughout the drawings to refer to the same or like parts.

### DETAILED DESCRIPTION

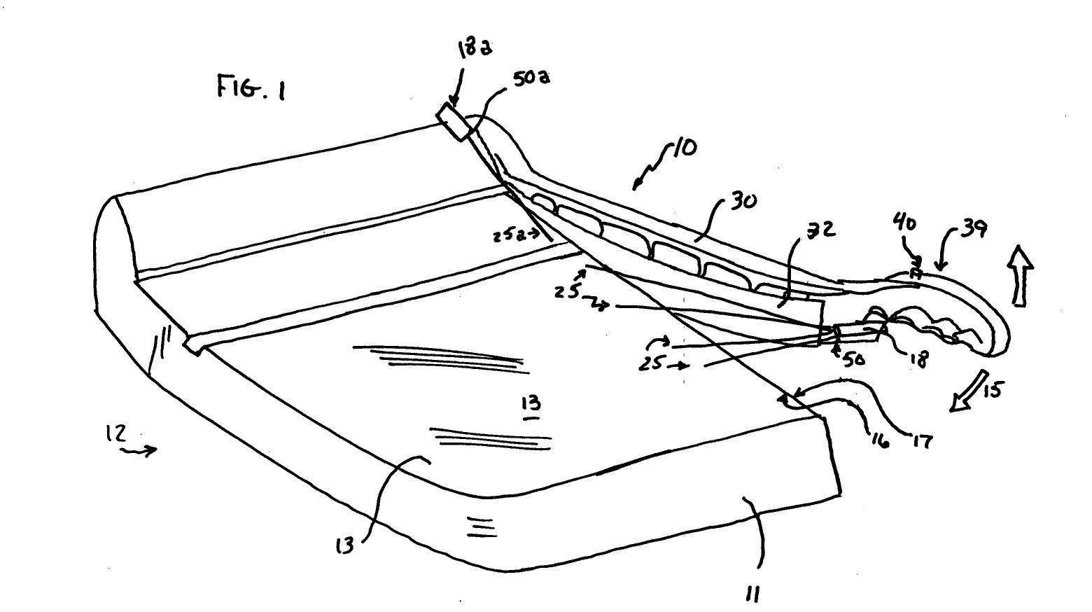

For the purpose of the description herein, the terms “upper,” “lower,” “right,” “left,” “rear,” “front,” “vertical,” “horizontal,” and derivatives thereof shall relate to the invention as oriented in FIG. 1 with the front 11 of the apparatus being generally at the bottom-right as shown. However, it is to be understood that the invention may assume various alternative orientations, except where expressly specified to the contrary. It is also to be understood that the specific devices and processes illustrated in the attached drawings, and described in the following specification are simply exemplary embodiments of the inventive concepts defined in the appended claims. Hence, specific dimensions and other physical characteristics relating to the embodiments disclosed herein are not to be considered as limiting, unless the claims expressly state otherwise.

Before explaining embodiments of the invention in detail it is to be understood that the invention is not limited in its application to the details of construction and the arrangement of the components set forth in the following description or illustrated in the drawings. The invention is capable of other embodiments or being practiced or carried out in various ways. Also, it is to be understood that the phraseology and terminology employed herein is for the purpose of description and should not be regarded as limiting.

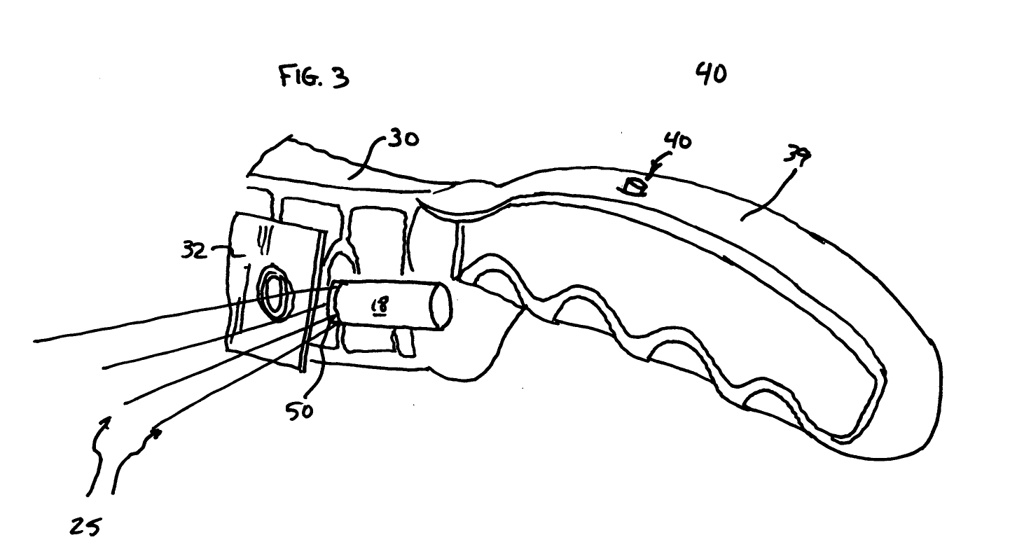

The present invention, in its broadest context, is in a cutter device 12. The cutter device 12 according to the present invention as generally illustrated in FIGS. 1-3 generally includes a base 13, a pivotally or translationally moveable cutting blade assembly 10 with a cutting blade 32, and a laser device 18. The guillotine type paper cutter embodiments of FIG. 1 and FIG. 3 include a stationary lower blade 16 with which the cutting blade assembly 10 cooperates.

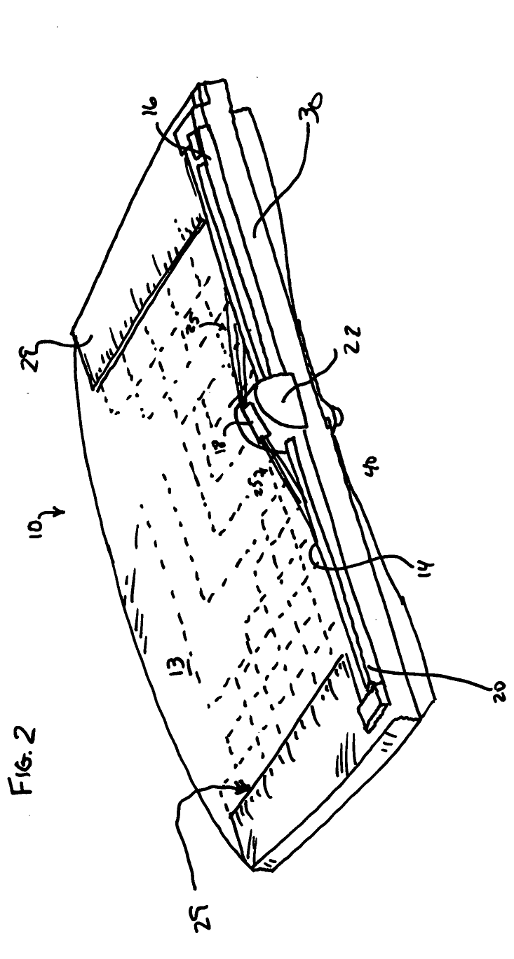

The laser device 18 can be mounted anywhere on the base 13, cutting blade assembly 10, or elsewhere on the cutter device 12, preferably in a location that is convenient, ergonomic or suited by any other design purpose. The sole limitation of the location of the laser device 18 is that the location must at least permit the projection of a laser line 25 along the line of cut of the cutting blade 32. For example, the laser line 25 may project along the base 13 along the lower blade edge of a guillotine-type cutter such as in FIG. 1 and FIG. 3, or along the travel line of the cutting blade 32 of a rotary trimmer, such as the trimmer of FIG. 2. The trimmer may include more than one laser device 18, and may further include features to allow a single laser device to project multiple lines onto the base 13 and any material to be cut that is placed on the base 13. Further, the base 13 can include one or more of an edge guide 29 (see FIG. 2), on one or more edges of the base 13, the edge guides offset at a predetermined angle, and is preferably disposed substantially perpendicular (i.e. at a 90 degree offset angle) to the line of cut for aligning the material to be cut. As further described herein, the laser device 18 may also project a line along other preselected orientations so as to allow the setting of margins and other desired features on the article to be cut.

The laser device 18 is positioned to project a beam or line of focused light 25 along the line of cut which, in the guillotine embodiment of FIG. 1, is along the outer edge 17 of the lower blade 16 where the cutting blade 32 meets the lower blade 16. (The figures, being for illustration purposes, may not show the line or beam of light 25 at the precise line of cut). The projected beam of light 25 will be visible on material placed on the base 13 for cutting, allowing precise positioning of the material to be cut in alignment with the cutting blade(s) 32, 16 and thus allowing the cut to be made precisely where desired.

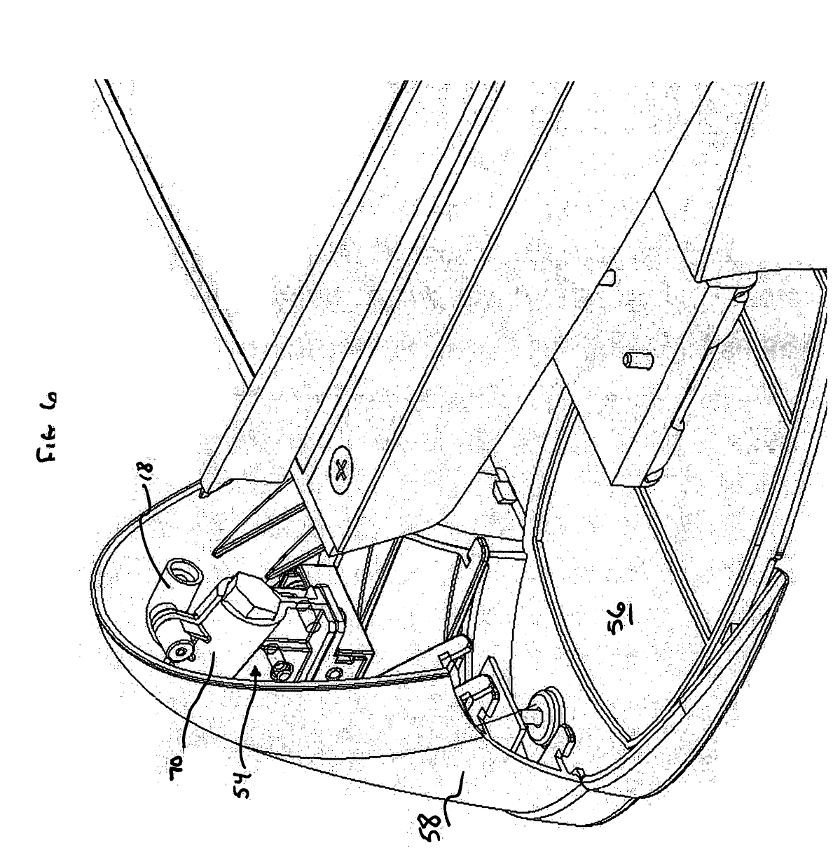

A power source is provided for the laser device 18. As illustrated in FIG. 6, the power source is preferably electricity from at least one battery, however, any suitable AC or DC power source appropriate for the laser device 18 can be employed. The power source is such as to project a beam in the visible spectrum, for example, at between about 630 and 670 nanometers in wavelength within the visible spectrum. Such power source is also adapted to function at low, safe power levels, for example, from about one to about five milliwatts of optical power, a safe level for normal use. The power source is controlled by known means, such as a circuit board employing electrical components to control electrical flow to the laser source 18 and other components, and to convert the electricity emitted by the power source to a desired voltage, amp, and the like. The connection from the power source to the laser device 18 is controlled by a switch, as further described herein. Preferably, the laser device 118 has a flying lead attachment or a battery terminal attachment. Optimally, the life of the laser diode should be about 5 thousand hours, and the size of the laser diode module would preferably be about 25 mm long and 18 mm in diameter.

In the preferred embodiment of the laser device 18, provided in association with the laser device 18 is an optical device for creating the line or lines from the point beam of the laser, such as a collimator and line generator, which are known in the art. An example of such an optical device may include a concave cylindrical lens with a negative focal length. The lens is adapted to fan the beam from the laser in a line corresponding to the intended blade line of cut. Preferably, the beam is between about 0.5 millimeters to about 1.5 millimeters wide, and more preferably is between about 0.7 to about 1.0 millimeters wide. Other appropriate optical devices, as for example, a binary optical element, for effecting a more uniform intensity fanning of the light beam from the laser may be utilized as is known in the optical arts. Another binary optical device that is preferred is one that generates any odd number of equal intensity beams in a fanned configuration. Instead of a continuous line, this device projects beams in a fanned configuration displaying multiple points on the material to be cut. In still another alternative, the optical element may include a beam splitter or the like, in combination with other elements, to generate two or more parallel lines having a predetermined, adjustable distance apart from one another. For example, two such beams can be provided having one line projected on the base 13 along the edge of the lower blade 16, and a second line projected inboard of the edge of the lower blade 16 to allow identification of precise border widths.

Preferably, the invention uses a standard visible-wavelength diode laser as the laser device 18. More preferably, the laser device 18 operates at about 650 nanometer of low, non-hazardous power, such as a Class II or Class IIIa laser device at about one milliwatt or less. Most preferably, the laser device 18 is directed through a line-generating or multiple beam optical element to illuminate the intended line of cut of the cutting blades 32, 16. The optical element can be a concave cylindrical lens with a negative focal length, but can also be a binary optical element, a binary line generating element, or a multiple beam splitter binary optical element.. Binary optic line generators have more consistency of laser intensity across the fan angle. A multiple beam line generating element could further enhance visibility of the cutting line since the laser pattern on the material to be cut would resemble a laser-lit dotted line.

As previously described, the cutter 12 further incorporates one or more means for switching the laser line on and off. Examples include a momentary switch 40 that could be located in the cutting blade handle 39 to be operated by the user. Another user operated switch can be a two-position switch 40 located on the blade handle 39, or on the cutter base 13. The cutter 12 could also utilize both types of switches, or multiple switches in parallel to allow for a user's preference or choice, or in series to require the operator to operate both switches, such as to assure consistent and preselected user hand positions for safety reasons. Preferably, the switch 40 includes a timing circuit that automatically turns the power to the laser off at the happening of a preselected event. For example, the timing circuit may turn the laser off after an elapsed period of predetermined length, or may turn off power when the blade is moved to a preselected position such as the load position and/or the cut completion position, or when a user deactivates or re-activates the same switch 40 or another switch.

In one embodiment, an automatic switching means is used (not shown in the figures) so that, for example, when the blade is moved into a predetermined pre-cutting position, the laser turns on and the laser is then switched off automatically when the blade has completed the cut. Examples of such switches include any available or known to those skilled in the art, such as a proximity switch, a capacitance switch, a pressure switch, an optical switch, and the like.

In a first embodiment, the cutter assembly 10 is of the known guillotine type, having a pivotally mounted cutter arm 30 having a handle 39 and the cutting blade 32 mounted thereto. Movement of the cutter arm 30 down towards the base 13 allows the cutting blade 32 to engage in a scissors-like action with a lower blade 16. The laser device 18 can be mounted on the cutter base 13 and project the laser line throughout the entire travel of the cutter arm 30. If the laser device 18 is mounted on the cutter arm 30, it is preferably mounted so that the laser line is projected on the base 13 when the blade is in its upper most position, just before the downwards cutting action 15. As one possible alternative, the laser device 18 can be mounted on the base 13, adjacent the back end of the cutting arm 30, as shown in FIG. 1.

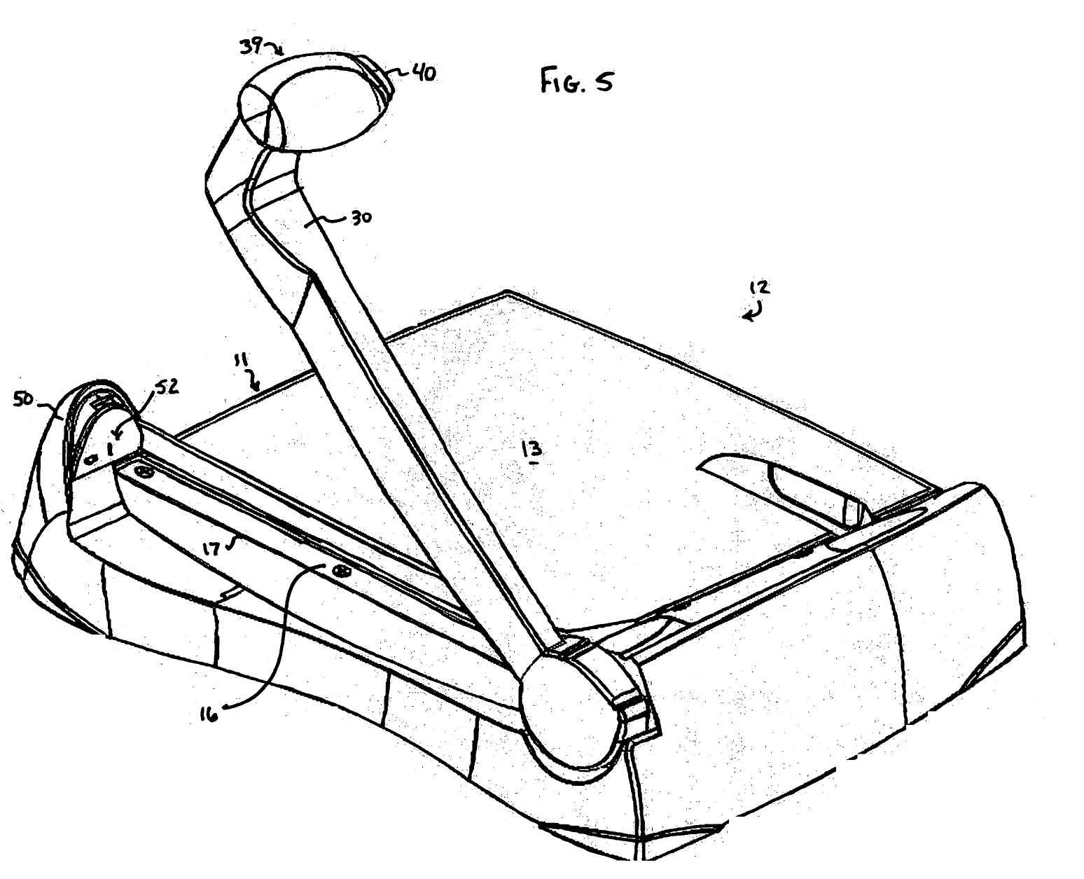

In an alternative embodiment of the guillotine-type trimmer shown in FIGS. 5-9, the laser device 18 is located in the base 13. Locating the laser device 18 in the base 13 provides the advantage of providing a relatively fixed line of light 25 as compared to the trimmer of FIG. 1, because the laser device 18 is provided independent of the position of the blade 32, arm 30, and handle 39. Preferably, the laser device 18 in the embodiment of FIG. 5 is located in a module located at one end, preferably the rear of the base 13 opposite of the pivot attachment of the cutter arm 30, and projects the line of light 25 along the edge of the lower blade 16 towards the pivot attachment. Preferably, as shown in FIGS. 5-6, the laser device 18 is in a module comprised of a housing portion 50 of the base 13. The housing portion 50 is configured to securely retain the laser device 18 to protect the device 18 from accidental and unintended contact by a user. The housing portion 50 includes means for allowing the line of light to pass through the housing 50 and to project along a preselected line such as a cutting line or margin line. The means for allowing the line of light to pass through the housing is provided adjacent the beam emitting end of the laser device, and includes, but is not limited to an orifice or slot 52 provided in the housing, a transparent portion provided in the wall of the housing 50, or an open wall portion of the housing 50.

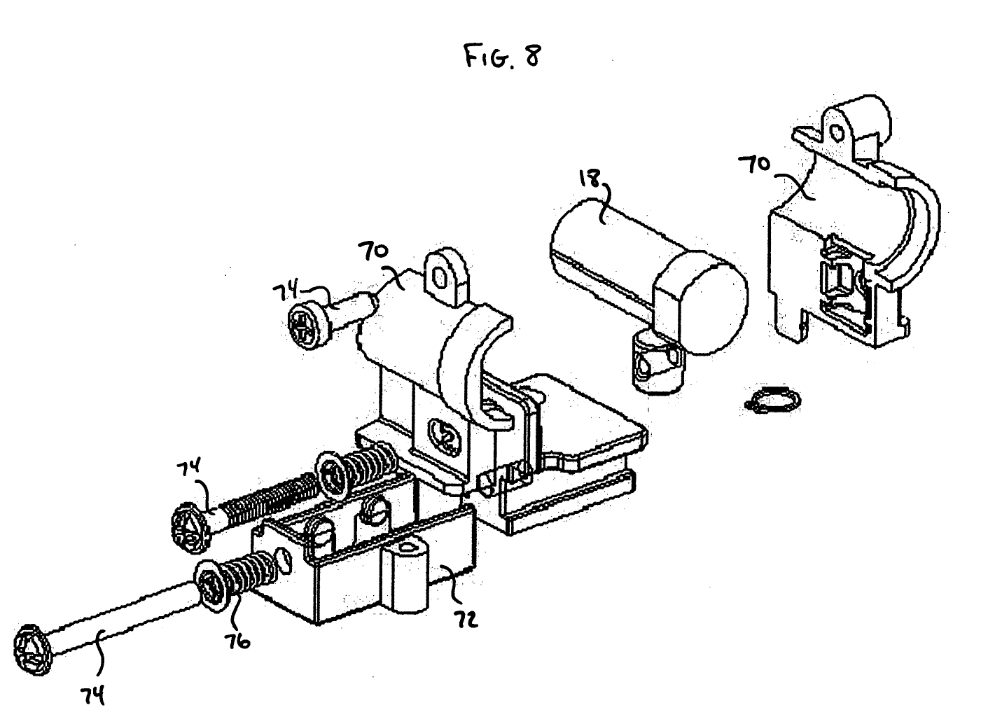

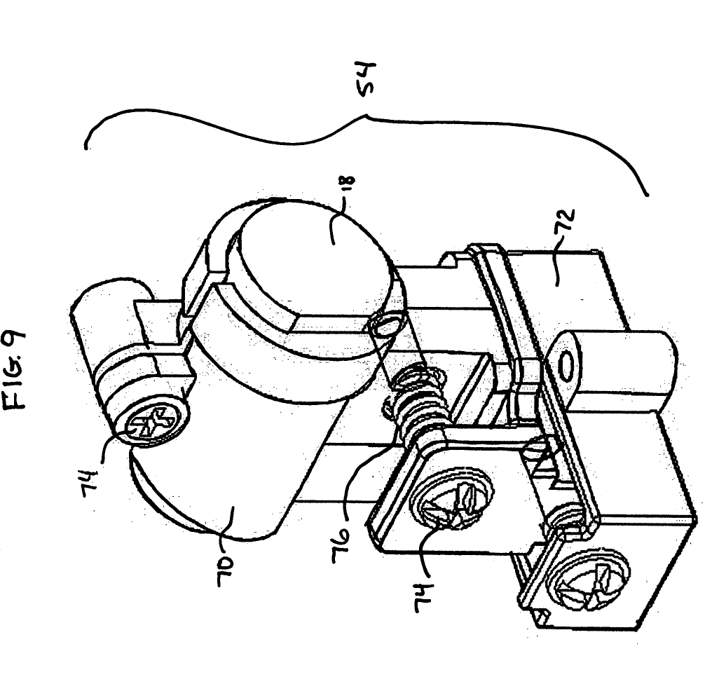

The housing 50 preferably further includes means for adjusting the position and orientation of the laser device 18 so as to direct the beam of light 25 along a predetermined path at a desired height and orientation. As shown in FIG. 6, the means for adjusting can include, for example, a mounting apparatus 54 having screws that can be actuated by a user to permit the mounting apparatus 54 to removably grip the mounted laser device 18, while allowing movement of the device 18 vertically and horizontally, as well as axially. When the desired position is obtained, the user tightens the adjustable mounting means to secure the laser device 18 in the desired selected position. A preferred embodiment of the mounting apparatus 54 is shown in FIGS. 8-9, and comprises two concave sides 70 that, when joined to a bottom portion 72 such as by screws 74 or the like, tensionally or frictionally hold the laser device 18 in a desired position and orientation. The bottom portion 74 is in turn adjustably mounted to the housing 50 by screws 74 or the like so as to tensionally or frictionally secure the laser device 18 in the preselected position and orientation. Preferably, the screws 70 include tension-maintaining means such as springs 76 axially mounted on the screws 70 to maintain tension on the joined sides 70.

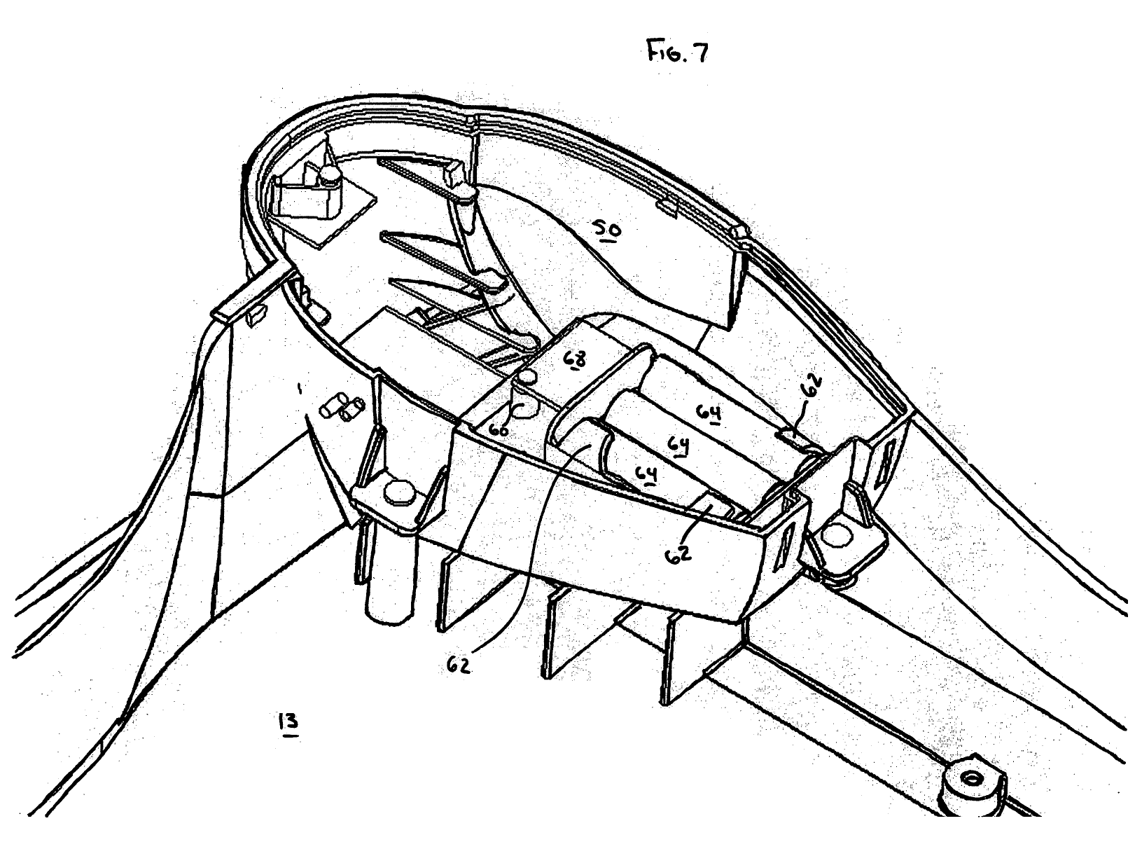

Preferably, as shown in FIG. 7, the housing portion 50 is of sufficient size and volume to permit the laser device 18 to be housed in close proximity to a connected power source 60. More preferably, the housing portion 50 includes a battery mount 62 configured for removably receiving and retaining at least one battery 64, and having electrical connections with the laser device 18 for transmitting electrical power from the battery 64 to the laser device 18 upon activation of a switch configured to control the electrical connection therebetween. Most preferably, the housing portion 50 further includes a circuit board mounting 66 for securely receiving and retaining a circuit board 68 for controlling the electrical connectivity and features of the trimmer. As further shown in FIG. 8, the housing portion 50 preferably includes a lower cover portion 56 that can be accessed and removed from the bottom of the base 13 to allow a user to replace a battery 64 or for a technician to service the laser device 18 and circuitry. As further shown in FIG. 8, the housing portion 50 can include a rear panel 58 in addition to, or as an alternative to, the lower cover 56.

While the base-mounted housing 50 is illustrated in the context of a guillotine-type trimmer in FIGS. 5-8, the base-mounted housing portion 50 described herein is equally applicable to other trimmer types, including but not limited to rotary type trimmers.

As previously described, the present invention is not limited to guillotine type trimmers. As shown in FIG. 2, a rotary-type cutter 12 is contemplated that generally includes a rail assembly 20 mounted in a fixed or pivotal configuration on the base 13 for supporting the cutting blade assembly. In such a cutter 12, the cutting assembly 10 may be mounted away from the edge of the base 13, in the center of the base 13, or in any combination thereof. A rotary type cutter may also be configured so as not to require the use of a lower blade, but instead use a durable or self-healing cutting pad 14 disposed over the base 13 and directly underneath the travel path of the cutting blade 24. The cutting blade assembly 10 generally includes a trolley 22 slideably mounted on the rail assembly 20 and a cover 26 removably mounted on the trolley 22 for supporting the circular cutting blade 24. The trolley 22 can include a spring assembly for biasing the cutting blade 24 to a storage position on the rail assembly 20. The cutting blade 24 is actuated by pushing the cutting blade assembly 10 down to move the cutting blade 24 into engagement with a self healing cutting pad 14 mounted on the cutting board base 13, and then pushed across the base 13 to cut or trim the material. As previously described, the switching means 40 could be configured to turn on the laser guide when the cutting blade is actuated.

In the rotary trimmer embodiment, the laser device 18 is preferably provided on the trolley 22 as illustrated in FIG. 2. Where the laser device 18 is mounted on the cutting blade assembly 10 incorporating a rotary cutting blade, the laser device 18 can be mounted such that it can be rotated 180 degrees to provide a line in both directions of cutting, since rotary blades on such trimmers cut in both directions of travel. Alternatively, a rotary cutting blade assembly could include two laser devices, one pointed in each opposite direction of travel, and alternately with a switching means capable of switching on the appropriate laser device for the current direction of travel of the blade assembly can be included. In yet another embodiment, the optical means used can be configured to project two separate lines in opposite directions. Alternatively, the laser device 18 can be mounted on the rail assembly 20.

Thus, it should be apparent that there has been provided in accordance with the present invention a cutter with a laser guide that fully satisfies the objectives and advantages set forth above. Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims.

While the invention has been described with reference to a preferred embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

1. A cutter for cutting paper and other flat material, the cutter comprising: a base; a manually operated cutting blade assembly moveably attached to the base, the blade assembly having a line of cut over which the operation of the blade assembly will cut the flat material; and at least one laser device mounted on the cutter and disposed to be capable of projecting a light beam to visually indicate the line of cut.

2. The cutter of claim 1, wherein the at least one laser device comprises at least one laser source, a power supply, and optical element means for configuring the light beam from the at least one laser source, adjusting means for adjusting the alignment of the light beam onto a selected area of the base, and mounting means for mounting the at least one laser source to the cutter.

3. The cutter of claim 2, wherein the optical element means comprises at least one of a collimator, line generator, beam splitter, and a concave lens with a negative focal length.

4. The cutter of claim 3 further comprising switch means for selectively turning the at least one laser source on and off.

5. The cutter of claim 4, wherein the switch means is at least one of a momentary switch, a toggle switch, a proximity switch, a capacitance switch, a pressure switch, and an optical switch.

6. The cutter of claim 4, wherein the at least one laser source is selected so as to provide a wavelength of between about 630 to about 670 nanometers at about 0.1 to about 5 milliwatts of power.

7. The cutter of claim 4, wherein the cutting blade assembly comprises a guillotine cutting blade provided on an arm pivotally attached to the base, and wherein the at least one laser device is mounted on the arm so as to allow a user to operate the switch to project a line of light to visually indicate the line of cut before operating the cutting blade to cut the flat material.

8. The cutter of claim 7, wherein the switch means includes at least one switch located on the cutter arm.

9. The cutter of claim 4, wherein the cutting blade assembly comprises a guillotine cutting blade provided on an arm pivotally attached to the base, and wherein the laser device is mounted in the base so as to project a line of light to visually indicate the line of cut before operating the blade to cut the flat material.

10. The cutter of claim 9, wherein the laser device is mounted in a housing portion provided in the base located opposite the point of attachment of the arm of the cutting blade assembly, the housing portion having mounting means for adjustably positioning and retaining the at least one laser source in a selected orientation.

11. The cutter of claim 10, wherein the housing portion further includes means for allowing the line of light to pass from the at least one laser source through the housing portion.

12. The cutter of claim 11, wherein the means for allowing the line of light to pass from a beam-emitting end of the at least one laser source through the housing is at least one of an orifice, slot, open wall portion, or transparent wall portion.

13. The cutter of claim 10, wherein the housing portion further includes a battery mount configured for removably receiving and retaining at least one battery for powering the at least one laser source.

14. The cutter of claim 13, wherein the housing portion further includes at least one removable cover portion of sufficient size so as to permit removal and replacement of the at least one battery by a user.

15. The cutter of claim 4, wherein the cutting blade assembly comprises a rail assembly moveably attached to the base, a trolley slideably attached to the rail assembly, and a rotary cutting blade rotatably mounted on the trolley, and wherein the laser device is mounted on the trolley so as to allow a user to operate the switch to project a line of light to visually indicate the line of cut before operating the cutting blade to cut the flat material.

16. The cutter of claim 15, wherein the at least one laser device is pivotally mounted on the trolley so as to allow a user to pivot the laser device to direct the line of light in an intended direction of travel of the trolley.

17. The cutter of claim 15, wherein the switch means includes at least one switch located on the cutting blade assembly.

18. The cutter of claim 15, wherein the cutting assembly further includes a flying lead attachment to connect the laser source to a power source.

19. The cutter of claim 15, wherein the laser device is mounted in the base so as to project a line of light to visually indicate the line of cut before operating the blade to cut the flat material.

20. A guillotine paper trimmer for cutting materials, comprising:
a base;
a lower blade section mounted on a side of said base;
an upper blade section pivotally mounted relative to said base, said upper blade section cooperating with said lower blade section for cutting materials placed on said base along a line of cut; and
an illumination source disposed on the trimmer so as to provide a visual indication of the line of cut on said materials.

21. The cutter of claim 20 wherein said illumination source comprises a laser.
